(19) United States
(12) Patent Application Publication
(10) Pub. No.: US 2025/0217185 A1
(43) Pub. Date: Jul. 3, 2025

(54) SYSTEMS AND METHODS FOR PHYSICAL CORE-SPECIFIC WEAR-BASED TASK SCHEDULING

(71) Applicant: Advanced Micro Devices, Inc., Santa Clara, CA (US)

(72) Inventors: Moumita Dey, Santa Clara, CA (US); Heather Lynn Hanson, Austin, TX (US); Aarti Choudhary, Bellevue, WA (US); Srilatha Manne, Bellevue, WA (US)

(73) Assignee: Advanced Micro Devices, Inc., Santa Clara, CA (US)

(21) Appl. No.: 18/398,811

(22) Filed: Dec. 28, 2023

(51) Int. Cl. G06F 9/48; G06F 9/50; G06F 11/00

(52) U.S. Cl. CPC G06F 9/4881; G06F 9/5044; G06F 11/008

(57) ABSTRACT

A computer-implemented method for physical core-specific wear-based task scheduling can include obtaining a wear metric for each physical core based of the plurality of physical cores of the at least one integrated circuit, wherein the wear metric is indicative of a physical condition of each physical core. The computer-implemented method can then schedule a plurality of tasks across at least one physical core of the plurality of physical cores based at least in part on the wear metric of each physical core of the plurality of cores. Various other methods, systems, and computer-readable media are also disclosed.

### BACKGROUND

Integrated circuit packages can use multiple processing cores to perform tasks of a workload. For example, multi-core processors can be employed in consumer computing devices, servers, across data centers, or in other applications. The scope of environmental impact of implementing multi-core logic circuit packages can be quantified depending upon the type of carbon emissions as operational footprint and embodied footprint. While operational footprint emissions can be derived from the energy consumption during hardware use, along with the carbon intensity of the energy source itself, embodied footprint emissions can originate from infrastructure construction and chip manufacturing, such as procuring raw materials, fabrication, packaging, and assembly. One of the ways to bring down overall carbon emissions is by accounting for emissions pertaining to the upstream and downstream supply chain, including the carbon emissions associated with the supply chain pertaining to multi-core logic circuit packages.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a block diagram of an example system for providing physical core-specific wear leveling across multiple physical cores of an integrated circuit package.

FIG. 2 is a flow diagram of an example method for providing physical core-specific wear leveling across multiple physical cores of an integrated circuit package.

FIG. 3 is a block diagram of an example workflow scheduler for providing physical core-specific wear leveling across multiple physical cores of an integrated circuit package.

FIG. 4 is a block diagram for an additional example workflow scheduler providing physical core-specific wear leveling across multiple physical cores of an integrated circuit package.

FIG. 5 is a block diagram for an additional example providing physical core-specific wear leveling across multiple physical cores of an integrated circuit package.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to systems and methods for assigning tasks across multiple physical cores of an integrated circuit so as to account for wear on individual cores. For example, as will be explained in greater detail below, by monitoring per-core performance and/or utilization of the cores of a multi-core logic circuit package and performing per-core workload scheduling based on such information, it can be possible to extend the useable life of the multi-core integrated circuit.

Integrated circuits, such as processing devices for central processing units, graphical processing units, data processing units, neural processing units, among others or any combination thereof, can experience wear and degradation as physical cores are utilized. Often, not all cores are utilized evenly. As a result, the cores can wear in an uneven manner, such that following some period of use, some cores can perform within acceptable performance metrics while others (e.g., more heavily used cores) can wear to the point that they fall outside of the acceptable performance metrics. When some cores start underperforming or performing outside of acceptable metrics, it can lead to replacement of the whole integrated circuit, even if many or most of the cores remain good. This can in some cases lead to undesirable increases in hardware costs as well as increases in environmental resource consumption, such as increased resources for manufacturing and delivery of computing hardware.

There could be advantages to workload assignment across cores that can support more even wear on cores, including, in some cases, extending the time by which cores are collectively operating within acceptable performance metrics which can result in delaying replacement of the integrated circuit.

Thus, variations and examples of a workload scheduler of the present disclosure can collect performance data from a core-level monitor that monitors per-core performance metrics, and use the per-core performance metrics to determine a degree of wear, or “aging,” of each core in a particular multi-core logic circuit package. As a result, the workload scheduler can schedule the tasks of incoming workloads to cores in the multi-core logic circuit package according to a physical condition of each core as quantified with a wear metric. In doing so, the workload scheduler can extend the operating life and useable performance of the multi-core logic circuit package by more evenly utilizing the cores thereof, thus extending the time to which any core or subset of cores falls below the threshold of acceptable performance. By extending the operating life of the IC package on the whole, less waste is created by replacing IC packages that have degraded beyond viability, thus reducing costs as well as emissions, including embodied footprint emissions.

As will be described in greater detail below, the present disclosure describes various systems and methods for physical core-specific wear-based task scheduling by obtaining a wear metric for each physical core of the plurality of physical cores of the at least one integrated circuit, where the wear metric is indicative of a physical condition of each physical core; and scheduling a plurality of tasks across at least one physical core of the plurality of physical cores based at least in part on the wear metric of each physical core of the plurality of physical cores.

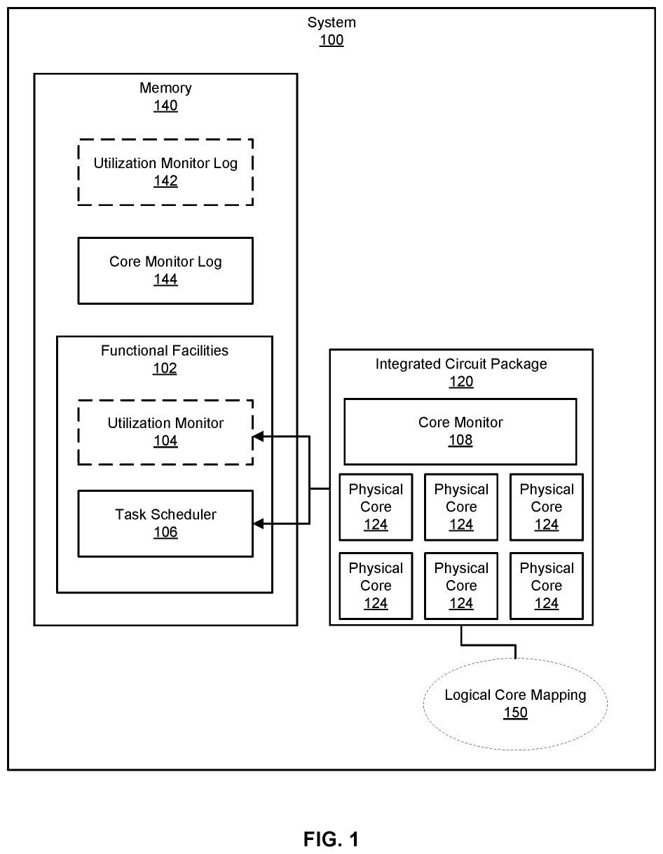

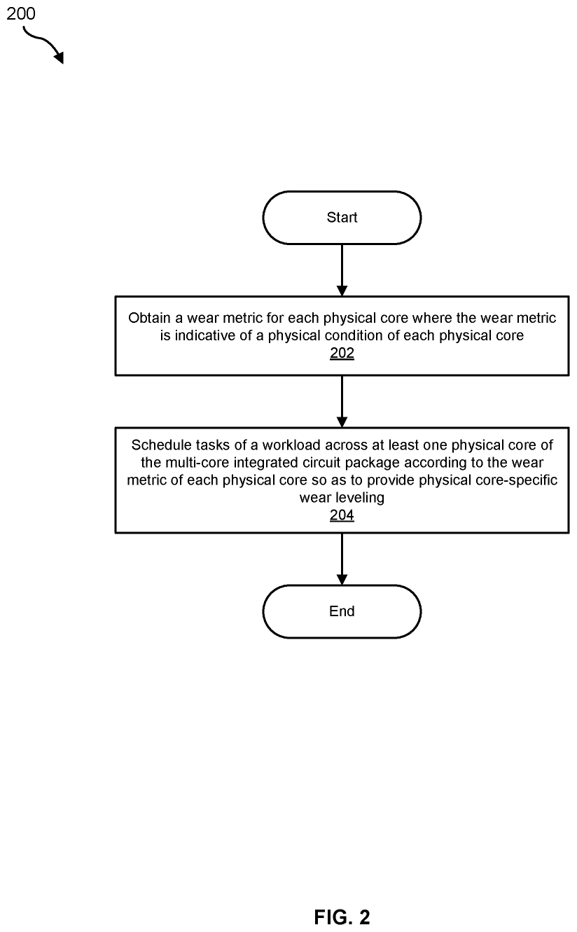

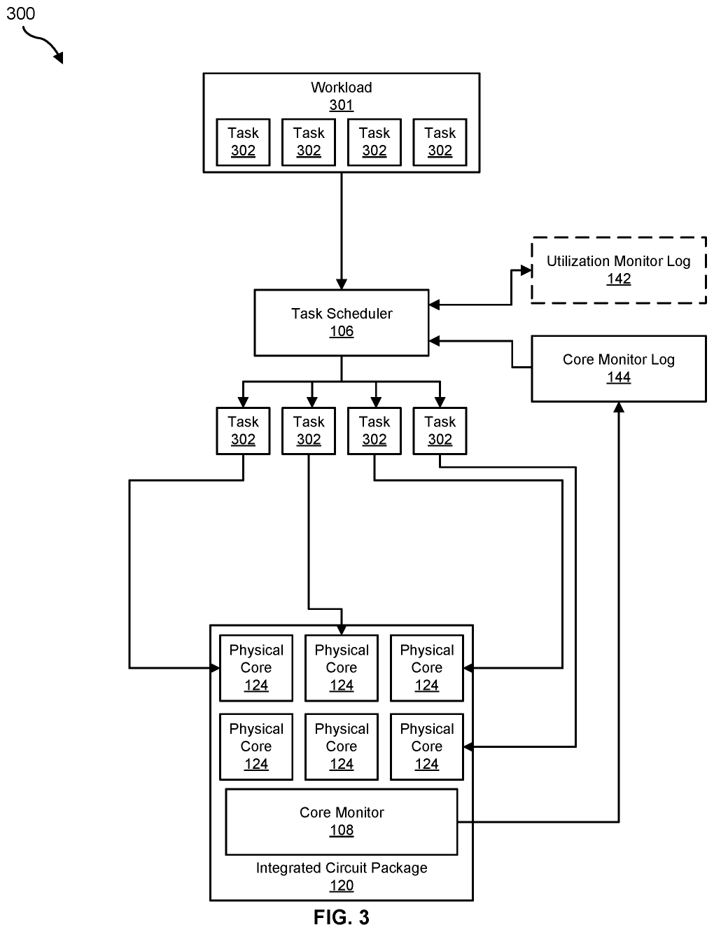

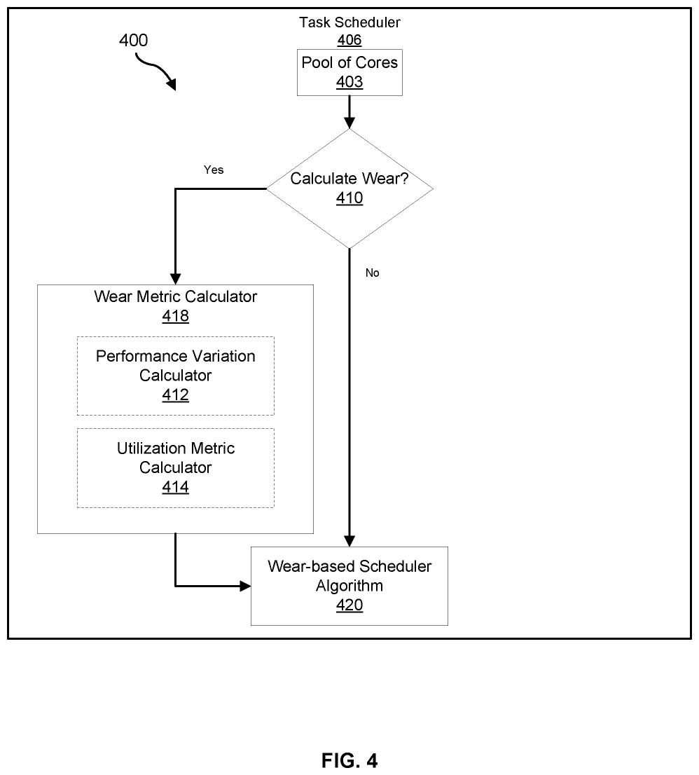

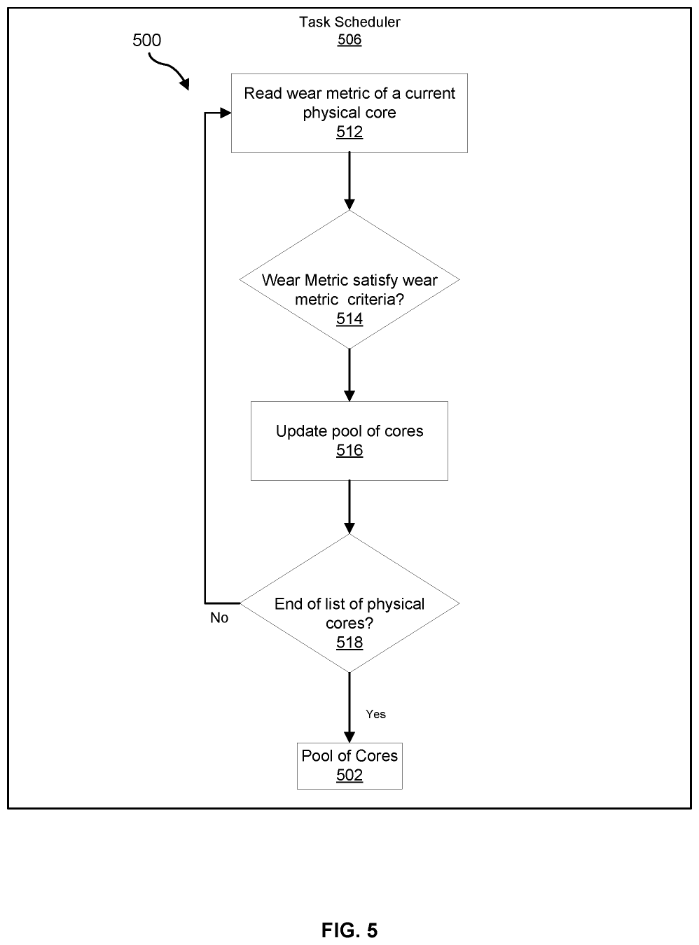

The following will provide, with reference to FIG. 1, detailed descriptions of example systems for physical core-specific wear-based task scheduling. Detailed descriptions of corresponding computer-implemented methods will also be provided in connection with FIG. 2. In addition, detailed descriptions of example wear-based task scheduling methods are also provided in connection with FIG. 3. In addition, detailed descriptions of additional example wear-based task scheduling methods are also provided in connection with FIG. 4. In addition, detailed descriptions of example wear-based physical core task assignability designation methods are also provided in connection with FIG. 5.

FIG. 1 is a block diagram of an example system 100 for physical core-specific wear-based task scheduling. As illustrated in this figure, example system 100 can include one or more facilities 102 for performing one or more operations. As will be explained in greater detail below, facilities 102 can include a utilization monitor 104 software package and a task scheduler 106 software package. Although illustrated as separate elements, one or more of software packages 102 in FIG. 1 can represent portions of a single software package or application. Herein, the term “software package” refers to at least one software component and/or a combination of at least one software component and at least one hardware component which are designed/programmed/configured to manage/control other software and/or hardware components (such as the libraries, software development kits (SDKs), objects, etc.).

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In certain implementations, one or more of facilities 102 in FIG. 1 can represent one or more software applications or programs that, when executed by a computing device, can cause the computing device to perform one or more operations. For example, and as will be described in greater detail below, one or more of facilities 102 can represent software packages stored and configured to run on one or more computing resources, such as a computing device and/or a server, among others or any combination thereof. In some embodiments in which facility 102 are implemented in software, one or more of facilities 102 may be implemented as firmware or other executable instructions. One or more of software packages 102 in FIG. 1 can also represent all or portions of one or more special-purpose computers or circuits (e.g., application specific integrated circuits (ASICs), accelerators, or other circuits) configured to perform one or more operations.

Techniques operating according to the principles described herein can be implemented in any suitable manner. Included in the discussion herein are a series of flow charts showing the steps and acts of various processes that monitor wear across processing cores of a physical circuit and/or assign tasks across multiple physical cores of an integrated circuit so as to account for wear on individual cores. The processing and decision blocks of the flow charts, and otherwise the discussion of functionality herein, represent steps and acts that can be included in algorithms that carry out these various processes. Algorithms based on these processes can be implemented as software integrated with and directing the operation of one or more single- or multi-purpose processors (including various forms of processing units, such as central processing units (CPUs), graphics processing units (GPUs), accelerated processing units (APUs), tensor processing unit (TPU), and others), or in some cases can be implemented as functionally-equivalent circuits such as a Digital Signal Processing (DSP) circuit, Field Programmable Gate Array (FPGA), or an Application-Specific Integrated Circuit (ASIC), or can be implemented in any other suitable manner. In implementations in which the techniques described herein are implemented as functionally-equivalent circuits like DSPs, FPGAs, ASICs, and the like, the circuit can include subcomponents that receive and perform tasks akin to cores of a multicore processing unit and thus can be monitored and assigned tasks in accordance with techniques described herein.

It should be appreciated that the flow charts included herein do not depict the syntax or operation of any particular circuit or of any particular programming language or type of programming language. Rather, the flow charts illustrate the functional information one of ordinary skill in the art can use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that can be implemented and can be varied in implementations of the principles described herein.

Accordingly, in some implementations, the techniques described herein can be embodied in computer-executable instructions implemented as software, including as application software, system software, firmware, middleware, embedded code, or any other suitable type of software. Such computer-executable instructions can be written using any of a number of suitable programming languages and/or programming or scripting tools, and also can be compiled as executable machine language code or intermediate code that is executed on a framework or virtual machine.

When techniques described herein are embodied as computer-executable instructions, these computer-executable instructions can be implemented in any suitable manner, including as a number of functional facilities, each providing one or more operations to complete execution of algorithms operating to perform wear leveling across physical cores of an integrated circuit package 120. A “functional facility,” however instantiated, is a structural component of a computer system that, when integrated with and executed by one or more computers, causes the one or more computers to perform a specific operational role. A functional facility can be a portion of or an entire software element and/or computing circuit. For example, a functional facility can be implemented as a function of a process, or as a discrete process, or as any other suitable unit of processing. If techniques described herein are implemented as multiple functional facilities, each functional facility can be implemented in its own way; all need not be implemented the same way. Additionally, these functional facilities can be executed in parallel and/or serially, as appropriate, and can pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities can be combined or distributed as desired in the systems in which they operate. In some implementations, one or more functional facilities carrying out techniques herein can together form a complete software package. These functional facilities can, in alternative implementations, be adapted to interact with other, unrelated functional facilities and/or processes, to implement a software program application, for example as a software program application such as a utilization monitor and/or a task scheduler for wear leveling across physical cores of an integrated circuit package. In other implementations, the functional facilities can be adapted to interact with other functional facilities in such a way as form an operating system. In other words, in some implementations, the functional facilities can be implemented alternatively as a portion of or outside of an operating system.

Some exemplary functional facilities are described herein for carrying out one or more tasks. It should be appreciated, though, that the functional facilities and division of tasks described is merely illustrative of the type of functional facilities that can implement the exemplary techniques described herein, and that implementations are not limited to being implemented in any specific number, division, or type of functional facilities. In some implementations, all functionality can be implemented in a single functional facility. It should also be appreciated that, in some implementations, some of the functional facilities described herein can be implemented together with or separately from others (i.e., as a single unit or separate units), or some of these functional facilities may not be implemented.

Computer-executable instructions implementing the techniques described herein (when implemented as one or more functional facilities or in any other manner) may, in some implementations, be encoded on one or more computer-readable media (e.g., memory 140) to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium can be implemented in any suitable manner, including as computer-readable storage media including the memory 140 of FIG. 1 (e.g., as a portion of a system 100) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that can be altered in some way during a process of creating the medium with embedded information, a process of recording information thereon, or any other process of encoding the medium with information. For example, a magnetization state of a portion of a physical structure of a computer-readable medium can be altered during a recording process.

Further, some techniques described herein comprise acts of storing information (e.g., data and/or instructions for, e.g.,) in certain ways for use by these techniques, such as in a utilization monitor log 142 and/or a core monitor log 144 as depicted in FIG. 1. In some implementations of these techniques—such as implementations where the techniques are implemented as computer-executable instructions—the information can be encoded on a computer-readable storage media. Where specific structures are described herein as advantageous formats in which to store this information, these structures can be used to impart a physical organization of the information when encoded on the storage medium. These advantageous structures can then provide functionality to the storage medium by affecting operations of one or more processors interacting with the information; for example, by increasing the efficiency of computer operations performed by the processor(s).

In some, but not all, implementations in which the techniques can be embodied as computer-executable instructions, these instructions can be executed on one or more suitable computing device(s) operating in any suitable computer system, including the exemplary computer system of FIG. 1, or one or more computing devices (or one or more processors of one or more computing devices) can be programmed to execute the computer-executable instructions. A computing device or processor can be programmed or otherwise including circuitry configured to execute instructions when the instructions are stored in a manner accessible to the computing device/processor, such as in a local memory (e.g., an on-chip cache or instruction register, a computer-readable storage medium accessible via a bus, a computer-readable storage medium accessible via one or more networks and accessible by the device/processor, etc.). Functional facilities that comprise these computer-executable instructions can be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

As illustrated in FIG. 1, example system 100 can also include one or more memory devices, such as memory 140. Memory 140 generally represents any type or form of volatile or non-volatile storage device or medium capable of storing data and/or computer-readable instructions. In one example, memory 140 can store, load, and/or maintain one or more of facilities 102 and/or a utilization monitor log 142 and/or a core monitor log 144. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As illustrated in FIG. 1, example system 100 can also include one or more integrated circuit (IC) packages 120. IC package 120 generally represents any type or form of hardware-implemented processing unit capable of interpreting and/or executing computer-readable instructions. In one example, IC package 120 can access and/or modify one or more of facilities 102 stored in memory 140. Additionally or alternatively, IC package 120 can execute one or more of facilities 102 to facilitate physical core-specific wear-based task scheduling. Examples of IC package 120 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical IC's.

As illustrated in FIG. 1, IC package 120 generally represents any type or form of integrated circuit device, system and/or component. In one example, IC package 120 can include one or more physical cores 124, a core monitor 108 configured to monitor operational characteristics and/or utilization of each physical core 124, among other component parts, variations or combinations of one or more of the same or any other suitable core monitor 108 and/or physical core 124. Examples of physical cores can include any circuitry software package for performing data-related tasks including processing and/or storage of data. Such physical cores can include, without limitation, logic cores, intellectual property (IP) cores, processor chiplets, portions of one or more of the same, variations or combinations of one or more of the same, or any other suitable physical cores.

In one or more variations, core monitor 108 can be a facility 102 in memory 140, or can be, as depicted, integrated with the IC package 120, or may be a separate software package, or any variation and/or combination thereof. In some embodiments in which core monitor 108 are implemented in software, core monitor 108 may be implemented as firmware or other executable instructions. One or more of core monitor 108 in FIG. 1 can also represent all or portions of one or more special-purpose computers or circuits (e.g., application specific integrated circuits (ASICs), accelerators, or other circuits) configured to perform one or more operations.

In one or more variations, as physical cores 124 are employed to execute tasks, including processing and/or storing data electronically, the application of electrical charge and/or power can degrade components and/or material of the physical cores 124. Due to a variety of factors, tasks are typically not uniformly distributed across the physical cores 124 throughout the lifespan of the IC package 120. Thus, some “high use” physical cores 124 would typically perform more tasks and thus experience more degradation, or “wear.” As the high use physical cores 124 continue to perform more tasks than other, lower use, physical cores 124, the accumulation of wear can result in the tasks being performed less efficiently and with lower performance, until the IC package 120 on the whole fails to meet performance standards, even though the lower use physical cores 124 have experienced relatively little wear, and thus would be capable of meeting the performance standards. By balancing tasks more uniformly across the physical cores, it can become less likely that particular physical cores 124 would be high use physical cores 124, and thus the risk of particular physical cores 124 causing the IC package 120 to fall below performance standards would be reduced.

Therefore, in one or more examples, as will be described in more detail below, system 100 can employ the facilities 102 to obtain one or more wear metrics for each physical core 124 of the IC package 120. In one or more examples, the wear metric is indicative of a physical condition of each physical core 124 based on, for example, operational characteristics and/or utilization as reported by the core monitor 108, the utilization monitor 104 or by one or more other components and/or facilities 102, portions of one or more of the same, variations or combinations of one or more of the same. In one or more variations, the operational characteristics and/or utilization of each physical core 124 can be reported directly to the facilities 102 by the core monitor 108, or can be accessed in core monitor log 144. In one or more variations, the operational characteristics and/or utilization of each physical core 124 can be detected by utilization monitor 104, or can be accessed in utilization monitor log 142. Accordingly, the facilities 102 may assess, continuously or periodically, the wear on each physical core 124 in order to identify and mitigate imbalances in the usage of physical cores 124. In so doing, the system 100 may assign tasks of workloads to physical cores 124 based on the degree of wear of each physical core 124 to enable per-core balancing of use, and therefore wear, of the physical cores 124.

In one or more examples, as will be described in more detail below, system 100 can employ task scheduler 106 to obtain the wear metric of each physical core 124 and to schedule one or more tasks for execution by one or more selected ones of physical cores 124 of the IC package 120 based on the wear metric of each physical core 124 so as to prevent particular physical cores 124 from experiencing an imbalance in wear relative to other physical cores 124, thus slowing the wear of each physical core 124 and extending the operational lifespan of the IC package 120.

In one or more examples, as will be described in more detail below, system 100 can employ logical core mapping 150 to store a mapping of/for physical cores 124 to logical cores. facilities 102 can schedule tasks to logical core(s) for execution by corresponding physical core(s) according to the logical core mapping 150. In one or more examples, the logical core mapping 150 maps the physical cores 124 on the die of the IC package 120 to a data construct having logical core indices representing the physical cores 124. Tasks can be assigned to physical cores 124 by utilizing the logical core indices representing each physical core 124. Thus, the system 100 can direct a task to a particular physical core 124 by logically assigned the task to the corresponding logical core index, which causes the IC package 120 to direct the bits of the task to the particular physical core 124 at execution time.

Example system 100 in FIG. 1 can be implemented in a variety of ways. For example, all or a portion of example system 100 can include, without limitation, a computing device a server, or other device and/or system having one or more IC packages with multiple physical cores therein, or any combination thereof. In one example, all or a portion of the functionality of facilities 102 can be performed by a computing device, server, and/or any other suitable computing hardware.

A computing device generally refers to any type or form of computing device capable of reading computer-executable instructions. In one or more variations, computing device can include administrative, configuration and/or hypervisor device(s) for managing the processor(s) and/or IC package 120. In one or more variations, computing device can include IC package 120 and facilities 102 for wear-based task scheduling across physical cores 124 of the computing device, e.g., using an operating system hypervisor of the computing device. In one or more variations, computing device can include a connection to remote or external computing hardware such that the remote or external computing hardware may perform, for the computing device, the wear-based task scheduling across physical cores 124. Additional examples of computing device include, without limitation, laptops, tablets, desktops, servers, cellular phones, Personal Digital Assistants (PDAs), multimedia players, embedded systems, wearable devices (e.g., smart watches, smart glasses, etc.), smart vehicles, so-called Internet-of-Things devices (e.g., smart appliances, etc.), gaming consoles, variations or combinations of one or more of the same, or any other suitable computing device.

A server generally refers to any type or form of computing device that is capable of wear-based task scheduling across physical cores 124 of integrate circuit package 120 of the server. In one or more variations, server can include administrative, configuration and/or hypervisor device(s) for managing the processor(s) and/or IC package 120. In one or more variations, server can include IC package 120 and a server-side implementation of facilities 102 for wear-based task scheduling across physical cores 124, e.g., using an operating system hypervisor of the server device. In one or more variations, server can include a connection to a remote or external computing hardware such that the remote or external computing hardware may perform, for the server, the wear-based task scheduling across physical cores 124 of server. Additional examples of server include, without limitation, storage servers, database servers, application servers, and/or web servers configured to run certain software applications and/or provide various storage, database, and/or web services. The system 100 can receive or otherwise obtain workloads and/or tasks via a network connection, local memory, or from any other source. A network generally refers any medium or architecture capable of facilitating communication or data transfer. In one example, network can facilitate communication using wireless and/or wired connections. Examples of a network include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, or any other suitable network.

Many other devices or subsystems can be connected to system 100 in FIG. 1. Conversely, all of the components and devices illustrated in FIG. 1 need not be present to practice the implementations described and/or illustrated herein. System 100 can also employ any number of software, firmware, and/or hardware configurations. For example, one or more of the example implementations disclosed herein can be encoded as a computer program (also referred to as computer software, software applications, computer-readable instructions, and/or computer control logic) on a computer-readable medium.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

FIG. 2 is a flow diagram of an example computer-implemented method 200 for physical core-specific wear-based task scheduling. The steps shown in FIG. 2 can be performed by any suitable computer-executable code and/or computing system, including system 100 in FIG. 1, and/or variations or combinations of one or more of the same. In one example, each of the steps shown in FIG. 2 can represent an algorithm whose structure includes and/or is represented by multiple sub-steps, examples of which will be provided in greater detail below.

As illustrated in FIG. 2, at step 202 a task scheduling engine of one or more of the systems described herein can obtain a wear metric for each physical core 124 so as to identify variations in the physical conditions of the physical cores 124 of the IC package. For example, the task scheduling engine can include task scheduler 106. Thus, task scheduler 106 can, as part of system 100 in FIG. 1, obtain a wear metric for each physical core 124 of physical cores 124 of IC package 120. The wear metric can be indicative of a physical condition of each physical core 124, including a degree of degradation or wear of each physical core 124, e.g., such as wear caused by the operation of each physical core 124 to perform prior tasks. Thus, the task scheduler 106 can perform wear-aware scheduling of tasks based on an input of a quantification of the physical condition of each physical core 124 in the IC package 120 so as to prevent any particular physical core(s) 124 from experience accelerated wear relative to other physical cores 124. As a result, the wear-aware scheduling can reduce the rate of deterioration of the fastest deteriorating physical core 124, thus reducing the degradation in performance of the IC package 120 more generally and extending its operational lifespan. In so doing, the wear-aware scheduling can delay the need to replace the IC package 120, thus reducing costs and the embodied footprint emissions of producing the replacement IC package 120, while also preserving the efficiency of the IC package 120 itself for a longer period of time.

In some implementations, an engine may be or include at least one software component and/or a combination of at least one software component and at least one hardware component which are designed/programmed/configured to manage/control other software and/or hardware components (such as the libraries, objects, functions, etc.). The software component(s) may be implemented as executable instructions that can be executed by the hardware component(s). Such instructions can in some cases be firmware or other executable instructions, as implementations are not limited to any particular form of instructions. As one example, the task scheduling engine of system 100 can include any one or more of utilization monitor 104, task scheduler 106, utilization monitor log 142, core monitor log 144, logical core mapping 150 and/or core monitor 108.

Wear can refer to damaging, gradual removal or deformation of one or more physical conditions, which can in some cases lead to degradation in performance. Examples of wear include, without limitation, heat degradation, thermal stress and/or stress due to thermal cycling, electrical wear, electromigration, material decomposition, erosive wear, abrasion, surface fatigue, corrosion, oxidation, cavitation, diffusive wear, among others or any combination thereof.

A metric can be one or more types of measurement, and a wear metric can be a measurement of wear, which can in some implementations be used as a means to quantify a degree of wear. Examples of metric include, without limitation, a performance measurement and/or operating characteristic such as, but not limited to, voltage draw, current draw, resistance, current leakage, operating temperature, switching speed, or any variation or combination thereof, or any correlation amongst one or more thereof.

In one or more variations, the term “task” may refer to a unit of execution or a unit of work assignable to an individual physical core. Alternatively or additionally, the term “task” may refer to any one or more of a computational process, thread, step, request, query, among other steps in a process executed by an IC, actions executed by an IC, unit of computation, or other IC execution(s) that can be scheduled to one or more physical cores for execution or any variation and/or combination thereof. Examples of task include, without limitation, a computational or processing step, thread, process or any variation or combination thereof.

In one or more variations, the term “schedule” or “scheduling” may refer to the action of assigning resources to perform tasks. Examples of schedule include, without limitation, matching a particular task to a particular physical core for execution in a particular order, or any variation or combination thereof.

In one or more variations, the term “physical core” may refer to electronic circuitry that executes instructions of a computer program and/or tasks thereof. Examples of physical core include, without limitation, a core of a multi-core processor and/or single core processor, or any other single or multi-core processing device/circuitry for, e.g., arithmetic, logic, controlling, and input/output (I/O) operations, among others, variations and/or combinations thereof.

The systems described herein can perform step 202 in a variety of ways. In some examples, core monitor 108 can monitor per-core level operating characteristics of each physical core 124 of IC package 120. The operating characteristics can include, without limitation, one or more of a voltage, a temperature, a current, a resistance, a switching speed, channel capacity, latency, completion time, service time, bandwidth, throughput, relative efficiency, scalability, performance per watt, compression ratio, instruction path length and speed up, clock frequency, interconnect delay, or any variation and/or combination thereof. Core monitor 108 can provide the per-core level operating characteristics to the facilities 102. Alternatively or in addition, core monitor 108 can provide the per-core level operating characteristics to core monitor log 144 for temporary and/or permanent storage. As such, core monitor log 144 can maintain a log of operating characteristics of each physical core 124 through time, e.g., by associating each entry of the per-core level operating characteristics with an associated time-stamp.

The core monitor 108 can provide the per-core level operating characteristics to the facilities 102 and/or the core monitor log 144 periodically or continuously. For example, for each physical core 124, core monitor 108 can provide the per-core level operating characteristics upon completion of a task, at a start of a task, at predetermined intervals (e.g., according to physical core cycles, execution time, or a combination thereof), or by any other period or any variation and/or combination thereof.

In some examples, utilization monitor 104 can monitor core utilization of each physical core 124 of the IC package 120. Core utilization can include, without limitation, task assignment to each physical core 124, number of clock cycles, number of clock cycles per task and/or operation, number of tasks and/or operations, compute time (as defined as by the amount of time spent processing tasks and/or operations, e.g., based on number of clock cycles multiplied by a clock cycle time), recency of task assignment, a current temperature, or any variation and/or combination thereof. Utilization monitor 104 can provide the per-core utilization to the facilities 102. Alternatively or in addition, utilization monitor 104 can provide the per-core utilization to utilization monitor log 142 for temporary and/or permanent storage. As such, utilization monitor log 142 can maintain a log of utilization characteristics of each physical core 124 through time, e.g., by associated each entry of the per-core utilization with an associated time-stamp.

The utilization monitor 104 can provide the per-core utilization to the facilities 102 and/or the utilization monitor log 142 periodically or continuously. For example, for each physical core 124, utilization monitor 104 can provide the per-core utilization upon completion of a task, at a start of a task, at predetermined intervals (e.g., according to physical core cycles, execution time, or a combination thereof), or by any other period or any variation and/or combination thereof.

In one or more variations, the task scheduling engine can obtain the wear metric for each physical core 124. The task scheduling engine can obtain the wear metric from another component, such as IC package 120 or from a stored log in memory 140, or from an external device. For example, task scheduler 106 can be in memory 140 and obtain the wear metric from one or more facilities 102 configured to determine and provide the wear metric based on per-core operating characteristics and, optionally, per-core utilization. In another example, task scheduler 106 can be in memory 140 and obtain the wear metric from one or more facilities 102 configured to determine and provide the wear metric based on per-core operating characteristics and, optionally, per-core utilization. In another example, task scheduler 106 can be in memory 140 and obtain the wear metric from one or more other facilities 102 configured to determine and provide the wear metric based on per-core operating characteristics and, optionally, per-core utilization. In another example, task scheduler 106 can be in memory 140 and obtain the wear metric from one or more other facilities 102 configured to determine and provide the wear metric based on per-core operating characteristics and, optionally, per-core utilization.

In one or more variations, the task scheduling engine can determine the wear metric for each physical core 124 based on the per-core operating characteristics logged in memory in core monitor log 144 and/or provided directly by core monitor 108. Alternatively or in addition, the task scheduling engine can determine the wear metric for each physical core 124 based on the per-core utilization characteristics logged in memory in utilization monitor log 142 and/or provided directly by utilization monitor 104.

In one or more variations, the wear metric of each physical core 124 represents a physical condition of each physical core 124, such as a degree of degradation, a degree of wear, an effective age, a flaw or performance characteristic, or other physical condition or any variation and/or combination thereof. Accordingly, the wear metric can be formulated to represent a variation, e.g., through time, in performance characteristics and, optionally, utilization characteristics of each physical core 124. For example, the variation can be a statistical measure of the performance characteristics and, optionally, utilization characteristics such as, e.g., an average for each of a series of windows of time, a rolling time average, a deviation from a baseline at each time stamp, a slope or derivative of a time series of the performance characteristics and, optionally, utilization characteristics, or other statistical measure of variation through time of the performance characteristics and, optionally, utilization characteristics, or any variation and/or combination thereof. Thus, as each physical core 124 varies in performance and/or utilization, e.g., either improving or degrading, the task scheduling engine can determine a current wear metric that represents a current state of each physical core 124.

As illustrated in FIG. 2, at step 204 one or more of the systems described herein can leverage the per-core wear metrics of the IC package 120 to schedule tasks based on the state and/or physical condition of each physical core 124 in order to optimize the distribution of tasks across the physical cores 124, e.g., to extend the life of the IC package 120, maximize performance, maximize efficiency, minimize compute time, minimize impact on the physical condition, or other optimization or any variation and/or combination thereof. For example, the task scheduling engine, including the task scheduler 106 can, as part of system 100 in FIG. 1, schedule tasks across at least one physical core 124 of physical cores 124 based at least in part on the wear metric of each physical core 124.

The systems described herein can perform step 202 in a variety of ways. In one example, the task schedule engine can rank the physical cores 124 according to magnitude of the wear metric of each physical core 124. The task scheduling engine can assign each successive task to an available physical core 124 having a least amount of wear based on the ranking, where an available physical core 124 is any physical core 124 that does not have a task assigned thereto during or overlapping in time with a task being assigned. The wear metric can include a value in a predefined scale, where a higher value indicates a greater degree of wear (an “ascending wear scale”), or where a lower value indicates a greater degree of wear (a “descending wear scale”). Accordingly, the ranking can include an ascending rank order for a wear metric on the ascending wear scale such that physical cores having the lowest wear metric value (least amount of wear) are closer to the “top” of a ranked list that is ranked according to the rank order. Similarly, the ranking can include a descending rank order for a wear metric on the descending wear scale such that physical cores having the highest wear metric value (least amount of wear) are closer to the “top” of a ranked list that is ranked according to the rank order.

In one or more variations, the task scheduling engine can curate a pool of assignable physical cores 124 based on wear metric criteria so as to retire physical cores 124 that fail to meet the wear metric criteria and/or to reserve one or more physical cores 124 to replace retired physical cores 124. In some embodiments, the wear metric criteria may include one or more rules and/or thresholds defining whether wear of a physical core meets one or more conditions (e.g., has sufficiently little/low wear, has sufficiently little/low deviation from other cores, or other conditions that analyze a core or how a core compares to other cores) to be continued to be scheduled for tasks. In one or more variations, the wear metric of a physical core may be assessed against the wear metric criteria for each workload scheduled to the IC package. Where a physical core has a wear metric that fails to meet the wear criteria, the physical core may be made unassignable (e.g., retired) temporarily or permanently. For example, the physical core that fails to meet the wear metric criteria may be retired but reassessed at a later workload, after a period of time, upon a predetermined number of physical cores becoming retired, or for any other duration or any combination thereof. In another example, the physical core that fails to meet the wear metric criteria may be retired permanently, such that tasks of all future workloads may be prevented from being assigned to that physical core.

In one or more variations, the wear metric criteria can define limits on the wear metric. The limits can be a maximum or minimum position in a rank ordered list, where the rank ordered list orders each physical core 124 in ascending or descending order based on the associated wear metric, as detailed above. Alternatively or additionally, the limits can include a threshold on a magnitude of the wear metric of each physical core 124, where the threshold can be a maximum or minimum value depending on the scale chosen for the wear metric. For example, the wear metric may be on an ascending scale such that a higher value indicates a higher degree of wear. In another example, the wear metric may be on a descending scale such that a lower value indicates a higher degree of wear. Other criteria can also be employed, alone or in combination with any one or more of the above. For example, the wear metric criteria can include a threshold value defining, e.g., a maximum effective age or degree of degradation/wear for which a physical core 124 can be categorized as assignable. Alternatively or additionally, the wear metric criteria can include, without limitation, a minimum time since a last utilized, one or more minimum or maximum performance characteristics, one or more minimum or maximum utilization characteristics, a maximum temperature, a minimum temperature, a maximum or minimum ranking in the ranked list, or other wear metric criteria or any variation and/or combination thereof. Accordingly, each physical core 124 can be classified according to one or more classes including, without limitation, assignable, retired, reserve, temporarily non-assignable, or other classification indicating a temporary and/or permanent ability or inability to be assigned a task, or any variation or combination thereof.

In one or more variations, the pool of assignable physical cores 124 can have a preset size such that the pool at any given time includes a predetermined number of assignable physical cores having the least amount of wear according to the ranked list and/or the wear metric values. The pool can include physical cores that already have tasks assigned thereto, or can include only physical cores 124 that currently do not have any tasks assigned thereto. Thus, the preset size can be inclusive of physical cores 124 satisfying the wear metric criteria regardless of whether there are tasks assigned thereto, or can pertain to physical cores 124 satisfying the wear metric criteria and without tasks assigned thereto.

In one or more variations, the task scheduling engine can select from amongst the pool of assignable physical cores 124 for each successive task in a group of tasks. Thus, the task scheduling engine can iterate through the group of tasks to schedule each task to a particular assignable physical core 124 based on physical core availability and assignability. In one or more variations, the task scheduling engine can assign tasks to physical cores 124 before feeding the tasks to the IC package 120 for execution, or the task scheduling engine can assign individual tasks or groups of tasks successively and feeding each successive individual task or group of tasks to the IC package 120 for execution before assigning next individual task or group of tasks.

In one or more variations, the task scheduling engine can schedule tasks to the physical cores 124 using one or more rules and/or algorithms based on the wear metric of each physical core 124. In some examples, the rule(s) and/or algorithm(s) can use the wear metric among other inputs to schedule tasks for wear aware scheduling. The other inputs can include, for example, the performance characteristics of each physical processor. The rule(s) and/or algorithm(s) can include one or more optimization functions for, without limitation, maximizing throughput (the total amount of work completed per time unit), minimizing wait time (time from work becoming ready until the first point it begins execution), minimizing latency or response time (time from work becoming ready until it is finished in case of batch activity, or until the system responds and hands the first output to the user in case of interactive activity), maximizing fairness (equal CPU time to each process, or more generally appropriate times according to the priority and workload of each process), minimizing maximum wear (a highest wear metric of the physical cores 124 to which tasks are scheduled), minimizing average wear (an average wear metric of the physical cores 124 to which tasks are scheduled), or other optimization objective or any variation and/or combination thereof.

FIG. 3 is a flow diagram of an example computer-implemented method 400 for physical core-specific wear-based task scheduling. The steps shown in FIG. 3 can be performed by any suitable computer-executable code and/or computing system, including system 100 in FIG. 1, and/or variations or combinations of one or more of the same. In one example, each of the steps shown in FIG. 3 can represent an algorithm whose structure includes and/or is represented by multiple sub-steps, examples of which will be provided in greater detail below.

In one or more variations, the example computer-implemented method 300 can include task scheduler 106 receiving a workload 301 for processing by IC package 120. Workload 301 can include one or more threads, processes, data flows or other computing processing workloads or any variation and/or combination thereof. The workload can be provided as a batch processing input, as a stream, or any variation and/or combination thereof. In one or more variations, the workload 301 can include one or more tasks 302. A task may be a subcomponent of a workload, such as a subset of instructions to be performed for a workload, a particular thread to be executed from among a set of threads for a workload, a process to be executed from among a set of processes, or other unit of computation where the workload may include one or more such units of computation.

In one or more examples, tasks 302 can include software instructions in a programming language, machine code, binary, or other form or any variation or combination thereof. Each task 302 can include one or more instructions and/or sets of instructions that, upon provision to one or more physical cores 124, cause the physical core(s) 124 to execute the instruction(s) to produce an output. Thus, depending on the number and/or complexity of the instructions of each task 302, each task 302 can result in more or less physical core 124 cycles to complete execution. Thus, depending on the task 302, a physical core 124 can process the task 302 for a certain number of cycles, resulting in time, latency and wear on the physical core 124 to complete the task 302.

In one or more variations, the task scheduler 106 schedules each task 302 for execution in a particular order to a particular set of physical cores 124 based on, without limitation, the time, latency and/or wear associated with each task 302, as well as task priorities, affinities, among other attributes or any combination thereof, and by the wear metric associated with each physical core 124. To do so, task scheduler 106 can access the core metric for each physical core 124 in core monitor log 144. In one or more variations, task scheduler 106 can access operational characteristics of each physical core 124 in the core monitor log 144. As detailed above, the core monitor log 144 can log the operational characteristics measured by core monitor 108, including performance metrics such as, but not limited to, frequency scaling, voltage scaling, latency, resistance, current leakage, temperature, among other metrics indicative of performance of operation of each physical core 124 or any variation and/or combination thereof. Core monitor log 144 can log the operational metrics through time so as to track performance variation through time of each physical core 124. For example, metrics such as clock frequency can decrease through time under like voltage(s), thus indicating decreased performance and increased wear. In another example, metrics such as current leakage, latency, resistance and/or temperature can increase through time under like voltage(s) and/or clock frequency (ies). Accordingly, based on the performance variation of each physical core 124, task scheduler 106 can determine a wear metric indicative of a physical condition that underlies the performance variation.

Optionally, in one or more variations, task scheduler 106 can access utilization monitor log 142 in scheduling the tasks 302 across physical cores 124. In one or more examples, task scheduler 106 can access the utilization characteristics of each physical core 124 to determine, e.g., a temperature, a time since last use, a total processing time, among other utilization metrics of each physical core 124 or any variation and/or combination thereof. Task scheduler 106 can use the utilization characteristics to proactively mitigate wear of physical cores 124. For example, task scheduler 106 can assign tasks 302 to physical cores 124 within predefined temperature limits to prevent temperature rising to a level that can accelerate wear. In another example, task scheduler 106 can assign tasks 302 to physical cores 124 that have been unutilized for a predetermined minimal period of time since a last use to prevent utilizing a particular physical core 124 more than others.

In one or more variations, task scheduler 106 can schedule the tasks 302 based on the instructions of each task 302 and/or the wear metric of each physical core 124 and/or the utilization characteristics of each physical core 124. As such, task scheduler 106 can identify an optimal core assignment for each task 302 to optimize operation of the IC package 120 in execution of the workload 301.

In one or more variations, task scheduler 106 can optimize the core assignment of the tasks 302 to the physical cores 124 using one or more rules and/or algorithms. In some examples, the rule(s) and/or algorithm(s) can use the wear metric among other inputs to schedule tasks for wear aware scheduling. The other inputs can include, for example, the performance characteristics of each physical processor task priorities, affinities, among other attributes or any combination thereof. The rule(s) and/or algorithm(s) can include one or more optimization functions for, without limitation, maximizing throughput (the total amount of work completed per time unit), minimizing wait time (time from work becoming ready until the first point it begins execution), minimizing latency or response time (time from work becoming ready until it is finished in case of a batch activity, or until the system responds and outputs the first output to the user in case of interactive activity), maximizing fairness (equal CPU time to each process, or more generally appropriate times according to the priority and workload of each process), minimizing maximum wear (a highest wear metric of the physical cores 124 to which tasks are scheduled), minimizing average wear (an average wear metric of the physical cores 124 to which tasks are scheduled), or other optimization objective or any variation and/or combination thereof.

As a result, task scheduler 106 can assign tasks 302 to particular physical cores 124 based, at least in part, on the wear metric of each physical core 124 for wear-based task scheduling. Therefore, the rate of wear of each physical core 124 can be distributed across all physical cores 124 such that a degree to which a particular one or more physical cores 124 undergo accelerated wear relative to other physical cores 124 is minimized. As a result, reduction in performance of the IC package 120 as a whole that would result from such accelerated wear of one or more particular physical cores 124 may be avoided and the operational life of the IC package 120 can be extended.

In one or more variations, as the physical cores 124 process the respective tasks 302, core monitor 108 can monitor operation of each physical core 124 and update core monitor log 144, e.g., at a predetermined time (according to a trigger event and/or period of time) or continually in real-time. Accordingly, core monitor 108 can log, in core monitor log 144, real-time operational characteristics of each physical core 124, such as real-time performance metrics. Task scheduler 106 can use the updated core monitor log 144 to obtain an updated wear metric for each physical core 124. In one or more examples, task scheduler 106 can use the updated wear metric in scheduling tasks 302 of subsequent workloads 301, and/or to modifying scheduling of remaining un-processed tasks 302 of the workload 301 prior to feeding the remaining un-scheduled tasks 302 to IC package 120.

FIG. 4 is a flow diagram of an example computer-implemented method 400 for physical core-specific wear-based task scheduling. The steps shown in FIG. 4 can be performed by any suitable computer-executable code and/or computing system, including system 100 in FIG. 1, and/or variations or combinations of one or more of the same. In one example, each of the steps shown in FIG. 4 can represent an algorithm whose structure includes and/or is represented by multiple sub-steps, examples of which will be provided in greater detail below.

In one or more variations of system 100, task scheduler 406 can receive a workload (such as workload 301 detailed above) and schedule tasks thereof across a pool of cores 403. The pool of cores 403 can include the physical cores 124 or a subset thereof, the subset including one or more assignable physical cores designated as eligible for assignment, as detailed above.

To do so, in one or more variations, task scheduler 406 can determine whether to calculate wear of each physical core at block 410. For example, calculating wear can be unnecessary when IC package 120 is new because each physical core 124 can be assumed to have a nominal wear metric. In another example, wear can be calculated at predetermined intervals of time and/or after IC package 120 processes a predetermined number of workloads and/or tasks. Thus, until the predetermined interval and/or predetermined number of workloads and/or tasks, task scheduler 406 can determine to not calculate wear metrics under the assumption that a degree of additional wear since the last calculation is outweighed by the compute cost and/or latency incurred by calculating wear. In one or more variations, where task scheduler 406 determines in block 410 to not calculate wear, task scheduler 406 can proceed directly to wear-based scheduler algorithm 420 for wear-based scheduling of the tasks based on a previous and/or assumed wear metric for each physical core 124.

In one or more variations, where task scheduler 406 determines to calculate wear, task scheduler 406 can determine a performance variation of each physical core 124 using performance variation calculator 412. Performance variation calculator 412 can access operational characteristics of each core, e.g., in core monitor log 144, to determine a change and/or trend in performance metric(s) of each physical core 124.

In one or more examples, performance variation calculator 412 can determine performance variation in each physical core 124 such as a change to clock frequency at a particular voltage(s) as a function of time. In one or more examples, performance variation calculator 412 can determine performance variation in each physical core 124 such as a change to voltage at a particular clock frequency (ies) as a function of time. Other examples include, without limitation, variations to current leakage, latency, resistance and/or temperature as a function of time, among other performance variations or any variation and/or combination thereof. In one or more variations, the performance variation can be represented by a value or set of values on an ascending scale such that a higher value indicates a higher performance variation. In another example, the performance variation may be on a descending scale such that a lower value indicates a higher performance variation (e.g., a lower performance consistency). In one or more examples, the performance variation may be a set values, where the set of values are on a combination of ascending and descending scales.

Optionally, instead of or in addition to performance variation calculator 412, task scheduler 406 can employ a utilization metric calculator 414 to measure utilization of each physical core 124. Utilization metric calculator 414 can access utilization monitor log 142 in scheduling the tasks across physical cores 124. In one or more examples, utilization metric calculator 414 can access the utilization characteristics of each physical core 124 to determine metrics including without limitation, e.g., a temperature, a time since last use, a total processing time, among other utilization metrics of each physical core 124 or any variation and/or combination thereof. In one or more variations, the utilization metric can be represented by a value or set of values on an ascending scale such that a higher value indicates a higher utilization. In another example, the utilization metric may be on a descending scale such that a lower value indicates a higher utilization. In one or more examples, the utilization metric may be a set values, where the set of values are on a combination of ascending and descending scales.

In one or more variations, task scheduler 406 can use a wear metric calculator 418 to calculate a wear metric for each physical core 124 based on, e.g., the performance variation and/or the utilization metric of each physical core 124. Wear metric calculator 418 can calculate the wear metric as an aggregation of the performance variation(s) and/or the utilization metric(s), including, without limitation, a weighted sum, a weighted average, a sum, an average, a standard deviation, a weighted standard deviation, an exponential function, a regression function, or any variation and/or combination thereof to represent a physical condition of an associated physical core 124 associated with wear. In one or more variations, the wear metric can be represented by a value or set of values on an ascending scale such that a higher value indicates a higher degree of wear. In another example, the wear metric may be on a descending scale such that a lower value indicates a higher degree of wear. In one or more examples, the wear metric may be a set values, where the set of values has a mix of values that are on ascending and descending scales.

In one or more variations, wear-based scheduler algorithm 420 can schedule tasks across physical cores 124 based on the wear metric of each physical core 124. In one or more examples, wear-based scheduler algorithm 420 can order the tasks for execution. For each successive task in the order, wear-based scheduler algorithm 420 can assign the successive task to a physical core 124 in the pool of cores 403 based on the wear metric of each physical core 124 in the pool of cores 403. For example, the physical core 124 can be selected as a physical core 124 that is not currently scheduled to execute a task of the workload (e.g., is available for scheduling) and has a lowest degree of wear as indicated by the wear metric relative to other physical cores 124 that are available for scheduling.

Alternatively or additionally, the physical core 124 can be selected based on one or more goals and/or optimization functions for, without limitation, maximizing throughput (the total amount of work completed per time unit), minimizing wait time (time from work becoming ready until the first point it begins execution), minimizing latency or response time (time from work becoming ready until it is finished in case of batch activity, or until the system responds and hands the first output to the user in case of interactive activity), maximizing fairness (equal CPU time to each process, or more generally appropriate times according to the priority and workload of each process), minimizing maximum wear (a highest wear metric of the physical cores 124 to which tasks are scheduled), minimizing average wear (an average wear metric of the physical cores 124 to which tasks are scheduled), or other optimization objective or any variation and/or combination thereof.

FIG. 5 is a flow diagram of an example computer-implemented method 500 for physical core-specific wear-based task scheduling. The steps shown in FIG. 5 can be performed by any suitable computer-executable code and/or computing system, including system 100 in FIG. 1, and/or variations or combinations of one or more of the same. In one example, each of the steps shown in FIG. 5 can represent an algorithm whose structure includes and/or is represented by multiple sub-steps, examples of which will be provided in greater detail below.

In one or more variations, the task scheduling engine can define a pool of cores 502 to which tasks can be scheduled for execution, where one or more physical cores 124 can be unviable for scheduling of tasks. For example, the one or more unviable physical cores 124 can have experienced sufficient wear so as to be in a physical condition that prevents completion of a task within a minimum service level, within a minimum efficiency, within a maximum temperature threshold, or any other threshold of viability or any variation and/or any combination thereof.

Thus, in one or more variations, task scheduler 506 can select a physical core 124 and read or otherwise obtain the wear metric of the physical core 124 at block 512. Task scheduler 506 can obtain the wear metric during scheduler (e.g., as detailed with respect to FIGS. 2, 3 and/or 4 above), access the wear metric in a log, or calculate the wear metric from operational characteristics in core monitor log 144.

In one or more variations, based on the wear metric, task scheduler 506 can determine, at block 514, whether the wear metric satisfies one or more wear metric criteria. The wear metric criteria can include, without limitation, any criterion and/or threshold related to the physical condition of the physical core 124. For example, the wear metric criteria can be a threshold value of the wear metric correlated to a threshold condition of operation of the physical core 124, including, without limitation, efficiency, temperature, clock speed, or other performance and/or operation condition or any variation and/or combination thereof.

In one or more variations, based on the whether the wear metric satisfies the wear metric criteria, task scheduler 506 can update the pool of cores 502 at block 516. Updating the pool of cores 502 can include, without limitation, adding the physical core 124 to the pool of cores 502 so as to make the physical core an assignable core, remove the physical core 124 from the pool of cores 502 so as to make the physical core 124 an unassignable core, update a mapping of the physical core 124 to a logical core associated with the pool of cores 124, or other update to the pool of cores 502 based on the wear metric or any variation and/or combination thereof.

In one or more variations, task scheduler 506 can remove the physical core 124 from the pool of cores 502 where the physical core 124 does not satisfy the wear metric criteria. Doing so causes the physical core 124 to be unassignable as it is outside of the set of assignable physical cores. Thus, the physical core 124, when removed from the pool of cores 502, can be considered “retired” because the physical core 124 has a wear metric that is insufficient to be considered viable to execute tasks and is no longer eligible for scheduling of tasks. In one or more examples, retiring the physical core 124 can be a permanent designation or can be reassessed at later time, e.g., where the wear metric is a function of, at least in part, utilization characteristics that change over time. Thus, periodically, task scheduler 506 can repeat the method 500 with retired physical cores 124 to determine whether to update in block 516 the pool of cores to re-add a retired physical core 124 as an assignable physical core.

In one or more variations, the pool of cores 502 can include a subset of the physical cores 124 that includes reserve cores. The reserve cores can include one or more physical cores 124 that are viable but are held in reserve so as to be temporarily unassignable. The reserve cores provide a pool of cores that may have relatively low or no wear relative to assignable cores. Thus, the reserve cores provide a pool of viable cores that may be substituted into the set of assignable cores when a physical core that is currently assignable reaches a degree of wear that makes the physical core no longer viable. The reserve cores can include: a minimum and/or maximum number of the physical cores 124, one or more physical cores 124 having a wear metric below a reserve threshold that indicates sufficient viability or a sufficiently low wear or “low age”, a random selection of physical cores 124, a location-based selection of physical cores 124, one or more physical cores 124 having been utilized within a threshold utilization time, or a subset of physical cores 124 defined according to any other suitable methodology for identifying physical cores 124 to hold in reserve, or any variation and/or combination thereof. In one or more variations, upon the task scheduler 506 retiring a physical core 124, the task scheduler 506 can update the pool of cores by selecting a reserve core to add to the set of assignable cores so as to replace the retired physical core.

In one or more variations, the pool of cores 502 can include and/or modify the logical core mapping 150 that maps physical cores 124 to logical cores. In one or more variations, tasks can be assigned to physical cores 124 via logical core mappings where the task scheduler 506 is configured to target logical core identifiers for task assignments. The logical core identifiers can include, without limitation, indices starting at 1 and incrementing to the number of physical cores, starting at 0 and incrementing to the number of physical cores, starting at “A” and incrementing alphabetically, mapping to physical location on a die of the IC package 120, or by any other suitable identification methodology to define the physical cores 124 logically, or any variation and/or combination thereof.

Typically, the mapping is fixed, or at least a primary core (sometimes termed “core 0”) is fixed. Typically, scheduling tasks across the physical cores 124 can be based on order of the physical cores in the logical core mapping 150, such as scheduling tasks sequentially, e.g., core 0 being scheduled with a first task, core 1 being scheduled with a second task, etc. As a result, physical cores 124 mapped to indices that are earlier in the order may be scheduled tasks more often, particularly where the tasks of a workload do not require the use of all physical cores 124 in the IC package 120. Indeed, the primary core, or core 0, may be a default core for performing tasks such as initial boot-up or loading of a bootloader, operating system functions, or other low-level system functions or any combination thereof and thus may be used more often than any other physical core 124. As a result of the primary core being often a default core, the primary core may handle more work than other cores and, in some cases, the primary core can undergo higher wear than other physical cores 124.

Therefore, in one or more variations, task scheduler 506 can adjust logical core mappings 150 based on wear metrics. The task scheduler 506 can remap the physical core 124 mapped to the primary core in the logical core mapping 150 periodically and/or upon the primary core having a wear metric exceed a predetermined threshold. Accordingly, task scheduler 506 can determine, as one of the wear metric criteria at block 514, that the physical core 124 is mapped to the primary core and that the wear metric of the primary core does not satisfy the wear metric criteria and/or a primary core-specific wear metric criteria, task scheduler 506 can, at block 516, update the pool of cores 502 by adjusting the logical core mapping 150 to re-map another physical core 124 to the primary core.

Upon updating the pool of cores 502, task scheduler 506 can test, at block 518, whether the physical core 124 is the end of a list of the physical cores 124 to check. If yes, task scheduler 506 can output the pool of cores 502 for use in task scheduling, e.g., as the pool of cores 403 in FIG. 4 as detailed above. If no, task scheduler 506 can select a next physical core 124 and return to block 512.

As explained above in connection with FIGS. 1-5, an adaptive task scheduler that is physical core aging-aware to determine the physical cores on which the incoming task will be offloaded. The scheduler leverages the historical data on temperature and voltage variations arising from previous task execution behaviors to determine the current age of the physical core. The operating system-based scheduler then uses this age information to offload tasks among the different physical cores in a way that will result in an even wearing of the physical cores.

The proposed mechanism improves the longevity of IC packages, such CPUs including server CPUs. The wear leveling mechanism improved longevity by eliminating uneven wearing of the physical cores of the IC package, thereby reducing embodied emissions of the production and sale of IC packages.

The task scheduler can be a part of the operating system hypervisor of a compute resource. The compute resource can be in the form of a physical resource, such as one or more particular physical CPUs, or a logical or virtual compute resource running on one or more physical resources. A logical or virtual compute resource can include a virtual machine (VM), a container, or other resource or any combination thereof. The task schedule can have access to information about the current temperature and voltage per physical core of the physical resource. The task scheduler may leverage monitoring mechanisms that can determine the “age” of the physical core depending upon the history of, for example, without limitation, temperature and voltage variations. An example of such a monitor is the Failure In Time (FIT) monitor that exists in the firmware of some processors, which gives information about the wear of each physical Core Complex Die (CCD) based on the voltage and frequency margin shifts. The FIT monitor can be modified to provide information on a per-physical core basis. The task scheduler can also track the IC package utilization when a task is executed. This, along with the information from monitors such as the FIT monitor, can provide a means to quantify the age of the physical core.

Once the age per physical core is available, the task scheduler can use this data to schedule tasks in a sustainable manner as follows:

When a task arrives at the compute resource, the task scheduler can identify the set of physical cores that satisfy a wear metric criteria (e.g., the least wear or a degree of wear below a threshold level) and offload the tasks onto the set. Arbitrating the set of physical cores being used at a time can inhibit the asymmetric wearing among the physical cores.

If physical cores have aged, for example physical cores have aged with voltage guard bands reaching the end of the thresholds, the task scheduler can prevent future tasks from being executed on them. While in this mode, the IC package can be continued to be used with fewer active physical cores for a longer time.

The logical processor 0 is generally mapped to the physical processor 0, leading to a highly skewed consumption of the physical core 0. The task scheduler can have mechanisms to periodically map the logical processor 0 to other physical cores with less wear as indicated by a lower wear metric. Thus, even if the physical processor 0 reaches end-of-life, other physical cores can resume the role of logical processor 0 and continue safe execution.

In another embodiment, subset physical cores are set aside as reserves, to prolong the overall device life at the expense of using less than maximum number of physical cores initially. The retirement criteria can be manipulated to explicitly exclude a fraction of total physical cores from the pool. As physical cores in the initial pool receive more use, they increase in wear/decrease in expected lifespan, and eventually can become excluded from the pool. Meanwhile, the physical cores excluded initially do not experience wearing effects, and are fresh substitutes as other physical cores age out of service.

One or more variations can include a mechanism that is physical core wear-aware to schedule tasks to prevent asymmetric wearing of the physical cores in an IC package.

This approach tracks the wear of each physical core and maps tasks onto the eligible physical cores depending upon respective wear metrics based on temperature, voltage and utilization variations. Thus, a rate of wear of the physical cores can be reduced, improving the lifespan of devices using such IC packages such as servers, computers, smartphones, embedded systems, etc., and thus have additional downstream effects such as reducing carbon emissions due to production of new IC packages.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other network-based or cloud-based computing environment.

In some examples, all or a portion of example system 100 in FIG. 1 can represent portions of a private computing environment. Various functions described herein can be provided through a local and/or private computing environment (e.g., a computing environment that does not provide compute and/or software services over a public network) such as a non-network datacenter. Various functions described herein can be provided locally on a computing device, including, without limitation, a desktop computer, a laptop computer, a network attached storage (NAS), a media server, a smartphone, a tablet, among other computing devices or any combination thereof.

In various implementations, all or a portion of example system 100 in FIG. 1 can facilitate multi-tenancy within a cloud-based computing environment. In other words, the software packages described herein can configure a computing system (e.g., a server) to facilitate multi-tenancy for one or more of the functions described herein. For example, one or more of the software packages described herein can program a server to enable two or more clients (e.g., customers) to share an application that is running on the server. A server programmed in this manner can share an application, operating system, processing system, and/or storage system among multiple customers (i.e., tenants). One or more of the software packages described herein can also partition data and/or configuration information of a multi-tenant application for each customer such that one customer cannot access data and/or configuration information of another customer.

According to various implementations, all or a portion of example system 100 in FIG. 1 can be implemented within a virtual environment. For example, the software packages and/or data described herein can reside and/or execute within a virtual machine. As used herein, the term “virtual machine” generally refers to any operating system environment that is abstracted from computing hardware by a virtual machine manager (e.g., a hypervisor).

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using software packages that perform certain tasks. These software packages can include script, batch, or other executable files that can be stored on a computer-readable storage medium or in a computing system. In some implementations, these software packages can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
obtaining a wear metric for each physical core of a plurality of physical cores of at least one integrated circuit, wherein the wear metric is indicative of a physical condition of each physical core; and
scheduling a plurality of tasks across at least one physical core of the plurality of physical cores based at least in part on the wear metric of each physical core of the plurality of physical cores.

2. The method of claim 1, wherein:
the method further comprises identifying at least one assignable physical core of the plurality of physical cores that satisfies at least one wear metric criteria related to the physical condition, based at least in part on the wear metric of each physical core; and
scheduling the plurality of tasks comprises scheduling the plurality of tasks across the at least one assignable physical core.

3. The method of claim 2, wherein the at least one wear metric criteria comprises at least one of:
a threshold wear metric value, or
a threshold rank position in a ranked list that orders the plurality of physical cores according to the wear metric of each physical core.

4. The method of claim 1, further comprising:
accessing a history of performance variation for each physical core of the plurality of physical cores; and
scheduling the plurality of tasks according to the wear metric for each physical core of the plurality of physical cores based at least in part on the history of performance variation for each physical core.

5. The method of claim 4, wherein the performance variation comprises at least one of:
a voltage variation over time, or
a temperature variation over time.

6. The method of claim 1, further comprising:
identifying a reserve physical core set comprising at least one reserve physical core and an assignable physical core set comprising at least one assignable physical core of the plurality of physical cores; and
scheduling the plurality of tasks across the at least one assignable physical core of the assignable physical core set.

7. The method of claim 6, further comprising:
removing the at least one assignable physical core from the assignable physical core set in response to at least one particular wear metric associated with the at least one assignable physical core, the at least one particular wear metric not satisfying at least one wear metric criteria; and
adding the at least one reserve physical core to the assignable physical core set.

8. The method of claim 1, further comprising:
identifying a primary physical core of the plurality of physical cores, the primary physical core being mapped to a primary logical core; and
remapping a different physical core of the plurality of physical cores to the primary logical core based at least in part on a primary physical core wear metric not satisfying at least one wear metric criteria, the primary physical core wear metric being associated with the primary physical core based on the wear metric of each physical core.

9. The method of claim 1, further comprising:
logging at least one real-time performance metric for the at least one physical core upon the at least one physical core executing the plurality of tasks; and
updating a history of performance variation for each physical core based at least in part on the at least one real-time performance metric.

10. The method of claim 1, further comprising:
accessing a history of utilization for each physical core of the plurality of physical cores; and
scheduling the plurality of tasks according to the wear metric for each physical core based on the history of performance variation for each physical core and the history of utilization for each physical core.

11. A system comprising:
one or more circuits configured to:
obtain a wear metric for each physical core of a plurality of physical cores of at least one integrated circuit package, wherein the wear metric is indicative of a physical condition of each physical core; and
schedule a plurality of tasks across at least one physical core of the plurality of physical cores based at least in part on the wear metric of each physical core of the plurality of physical cores.

12. The system of claim 11, wherein the one or more circuits are further configured to:
identify at least one assignable physical core of the plurality of physical cores that satisfies at least one wear metric criteria related to the physical condition based at least in part on the wear metric of each physical core; and
schedule the plurality of tasks comprising scheduling the plurality of tasks across the at least one assignable physical core.

13. The system of claim 12, wherein the at least one wear metric criteria comprises at least one of:
a threshold wear metric value, or
a threshold rank position in a ranked list that orders the plurality of physical cores according to the wear metric of each physical core.

14. The system of claim 11, wherein the one or more circuits are further configured to:
access a history of performance variation for each physical core of the plurality of physical cores; and
schedule the plurality of tasks according to the wear metric for each physical core of the plurality of physical cores based at least in part on the history of performance variation for each physical core.

15. The system of claim 14, wherein the performance variation comprises at least one of:
a voltage variation over time, or
a temperature variation over time.

16. The system of claim 11, wherein the one or more circuits are further configured to:
identify a reserve physical core set comprising at least one reserve physical core and an assignable physical core set comprising at least one assignable physical core of the plurality of physical cores;
remove the at least one assignable physical core from the assignable physical core set in response to at least one particular wear metric associated with the at least one assignable physical core, the at least one particular wear metric not satisfying at least one wear metric criteria;
add the at least one reserve physical core to the assignable physical core set; and
schedule the plurality of tasks across the at least one assignable physical core of the assignable physical core set.

17. The system of claim 11, wherein the one or more circuits are further configured to:
identify a primary physical core of the plurality of physical cores, the primary physical core being mapped to a primary logical core; and
remap a different physical core of the plurality of physical cores to the primary logical core based at least in part on a primary physical core wear metric not satisfying at least one wear metric criteria, the primary physical core wear metric being associated with the primary physical core based on the wear metric of each physical core.

18. The system of claim 11, wherein the one or more circuits are further configured to:
log at least one real-time performance metric for the at least one physical core upon the at least one physical core executing the plurality of tasks; and
update a history of performance variation for each physical core based at least in part on the at least one real-time performance metric.

19. The system of claim 11, wherein the one or more circuits are further configured to:
access a history of utilization for each physical core of the plurality of physical cores; and
schedule the plurality of tasks according to the wear metric for each physical core based on the history of performance variation for each physical core and the history of utilization for each physical core.

20. A non-transitory computer-readable medium comprising one or more computer-executable instructions, wherein the one or more computer-executable instructions, when executed by at least one execution circuit, cause the at least one execution circuit to carry out a method comprising:
obtaining a wear metric for each physical core based of a plurality of physical cores of at least one integrated circuit package, wherein the wear metric is indicative of a physical condition of each physical core; and
scheduling a plurality of tasks across at least one physical core of the plurality of physical cores based at least in part on the wear metric of each physical core of the plurality of physical cores.
